(19) United States
(12) Patent Application Publication
(10) Pub. No.: US 2022/0323276 A1
(43) Pub. Date: Oct. 13, 2022

(54) EXTENDABLE PLATFORM LIFT ASSEMBLY

(71) Applicant: Scott Ivan Fenton, Sinclairville, NY (US)

(72) Inventor: Scott Ivan Fenton, Sinclairville, NY (US)

(21) Appl. No.: 17/656,312

(22) Filed: Mar. 24, 2022

Related U.S. Application Data
(60) Provisional application No. 63/173,819, filed on Apr. 12, 2021.

(51) Int. Cl. A61G 3/06

(52) U.S. Cl. CPC A61G 3/062

(57) ABSTRACT

An extendable lift assembly, including at least one leg assembly, each leg assembly of the at least one leg assembly including a bracket, a first arm pivotably connected to the bracket, a second arm pivotably connected to the first arm, a first actuator extending between the bracket and the first arm, and a strut extending between the bracket and the first arm, and a platform assembly pivotably connected to the second arm.

### CROSS-REFERENCE TO RELATED APPLICATIONS

This application claims the benefit under 35 U.S.C. § 119(e) of U.S. Provisional Patent Application No. 63/173,819, filed Apr. 12, 2021, which application is incorporated herein by reference in its entirety.

### FIELD

The present disclosure relates to the field of lifts, and more particularly, to an extendable lift for entering and exiting a vehicle, and even more particularly, to an extendable lift including a lift assist feature.

### BACKGROUND

Platform lifts for vehicles are well known for accommodating wheelchairs. Specifically, platform lifts for vehicles are designed to carry a user seated in a wheelchair onto and off of a vehicle, such as a van. However, current lift designs require a large amount of power (e.g., electrical and hydraulic) to operate, for example, when lifting users into and out of a vehicle.

Thus, there is a long felt need for a platform lift assembly that extends out of a vehicle opening, such as a doorway, to retrieve a user and carries the user into the vehicle with a lift assist to reduce power usage.

### SUMMARY

According to aspects illustrated herein, there is provided an extendable lift assembly, comprising at least one leg assembly, each leg assembly of the at least one leg assembly including a bracket, a first arm pivotably connected to the bracket, a second arm pivotably connected to the first arm, a first actuator extending between the bracket and the first arm, and a strut extending between the bracket and the first arm, and a platform assembly pivotably connected to the second arm.

In some embodiments, the first actuator is operatively arranged to displace the first arm circumferentially with respect to the bracket. In some embodiments, the first actuator is pivotably connected to the bracket at a first end and pivotably connected to the first arm at a second end. In some embodiments, the strut biases the first arm in a first circumferential direction with respect to the bracket. In some embodiments, the strut comprises a gas strut including a cylinder and a rod, wherein the strut is pivotably connected to the bracket at a first end and pivotably connected to the first arm at a second end. In some embodiments, the extendable lift assembly further comprises a third arm pivotably connected to the bracket at a first end and pivotably connected to the second arm at a second end. In some embodiments, the platform assembly comprises a platform pivotably connected to the second arm, and at least one plate pivotably connected to the platform. In some embodiments, the at least one plate comprises a first plate connected to a first end of the platform, and a second plate connected to a second end of the platform. In some embodiments, the platform assembly further comprises a second actuator operatively arranged to circumferentially displace the first plate relative to the platform, and a third actuator operatively arranged to circumferentially displace the second plate relative to the platform. In some embodiments, retraction of the first actuator displaces the at least one leg assembly and platform assembly in a first circumferential direction, and extension of the first actuator displaces the at least one leg assembly and platform assembly in a second circumferential direction, opposite the first circumferential direction.

According to aspects illustrated herein, there is provided an extendable lift assembly for a vehicle, comprising at least one leg assembly, each leg assembly of the at least one leg assembly including a bracket operatively arranged to be mounted to a floor of the vehicle, a first arm pivotably connected to the bracket, a second arm pivotably connected to the first arm, a first actuator extending from the bracket to the first arm, wherein the first actuator is operatively arranged to displace the first arm circumferentially with respect to the bracket, and a strut extending from the bracket to the first arm, and a platform assembly pivotably connected to the second arm.

In some embodiments, the first actuator is pivotably connected to the bracket at a first end and pivotably connected to the first arm at a second end. In some embodiments, the strut biases the first arm in a first circumferential direction with respect to the bracket. In some embodiments, the strut comprises a gas strut including a cylinder and a rod, wherein the strut is pivotably connected to the bracket at a first end and pivotably connected to the first arm at a second end. In some embodiments, the extendable lift assembly further comprises a third arm pivotably connected to the bracket at a first end and pivotably connected to the second arm at a second end. In some embodiments, the third arm is connected to the second arm at a position spaced apart from each end of the second arm. In some embodiments, the platform assembly comprises a platform pivotably connected to the second arm, and at least one plate pivotably connected to the platform. In some embodiments, the at least one plate comprises a first plate connected to a first end of the platform, and a second plate connected to a second end of the platform. In some embodiments, the platform assembly further comprises a second actuator operatively arranged to circumferentially displace the first plate relative to the platform, and a third actuator operatively arranged to circumferentially displace the second plate relative to the platform. In some embodiments, retraction of the first actuator displaces the at least one leg assembly and platform assembly in a first circumferential direction, and extension of the first actuator displaces the at least one leg assembly and platform assembly in a second circumferential direction, opposite the first circumferential direction.

In some embodiments, the platform lift assembly comprises a base plate, a platform, a platform side link that connects the base plate to the platform, a linear drive or actuator, and a gas piston. The platform side link connects to the platform, the platform being arranged to extend out of the vehicle to the ground. The base plate is operatively arranged to be secured to the floor of the vehicle. The linear drive or actuator is arranged to control movement of the platform side link and thus the platform, precisely. In some embodiments, the linear drive comprises a brake such that it doesn't drift (i.e., drift occurs in hydraulic powered platform lifts).

The gas piston utilizes compressed gas to assist the platform lift assembly in returning to its retracted position. For example, as the linear drive contracts, the platform linkage displaces the platform lift out of the vehicle and down to the ground. As this occurs, the gas piston retracts thereby compressing the gas within the piston. Once the occupant is loaded onto the platform, the linear drive expands thereby elevating the platform up to and/or into the vehicle. The compressed piston contributes force biasing the platform up to and/or into the vehicle, thus less power is required by the linear drive (i.e., less current/electricity is used, at least at the peak force requirement point, when compared to hydraulic lifts).

In some embodiments, the platform lift assembly comprises a sensor operatively arranged to detect the ground and/or the existence of an occupant. Such a sensor provides added safety. For example, the platform will only retract back up to the vehicle when the sensor detects that the occupant is positioned on the platform. Also, the sensor will ensure that the platform extends completely to the ground (i.e., the linear drive will continue to extend until the sensor communicates that the platform is engaged with the ground). The sensor may comprise any sensor technology suitable for detecting the presence of an occupant and proper positioning of the platform on the ground, for example, ultrasound, sonar, lidar, etc.

The platform lift assembly of the present disclosure saves time on deployment and stowing of a lift. Since the platform lift assembly comprises sensors, it can be completely autonomous (i.e., does not require an operator to be present). For example, once the vehicle stops, the door is opened and the lift deploys safely with sensors and then lifts the passenger into the vehicle and stows. Thus, the platform lift assembly may be considered a “smart” lift. In comparison, a hydraulic lift assembly is considered a “dumb” lift because it remains on until a switch is flipped to shut it off. Thus, hydraulic lifts require an operator to stand next to the lift, turn a switch on to activate the lift, and turn the switch off to stop the lift at the appropriate elevation (i.e., ground level or vehicle entrance level). The linear drive of the present disclosure provides feedback on position so the platform lift assembly may automatically shut off when the platform is at ground or vehicle entrance level.

In some embodiments, the platform lift assembly comprises a plurality of linear drives/actuator that are capable of synchronizing. In some embodiments, the linear drives provide position sensing and feedback. In some embodiments, the linear drives utilize a Controller Area Network (CAN bus) communication. In some embodiments, the linear drives and/or the platform lift assembly provides diagnostics on the performance of the linear drives. Examples of linear drives or actuators that may be used are THOMSON® ELECTRAK®, MAX JAC™, ELECTRAK MD™, ELECTRAK THROTTLE™, and ELECTRAK HD™ actuators.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1A is a top perspective view of an extendable lift assembly;

FIG. 1B is a bottom perspective view of the extendable lift assembly shown in FIG. 1A;

FIG. 2 is an exploded top perspective view of the extendable lift assembly shown in FIG. 1A;

FIG. 3 is a detail view of the extendable lift assembly taken generally at Detail 3 in FIG. 1A;

FIG. 4 is a detail view of the extendable lift assembly taken generally at Detail 4 in FIG. 1A;

FIG. 5 is a cross-sectional view of the extendable lift assembly taken generally along line 5-5 in FIG. 1A;

FIG. 6 is a top perspective view of the platform assembly shown in FIG. 1A;

FIG. 7A is a side elevational view of an extendable lift assembly in a partially stowed position;

FIG. 7B is a side elevational view of the extendable lift assembly shown in FIG. 7A, in a partially extended position;

FIG. 7C is a side elevational view of the extendable lift assembly shown in FIG. 7A, in a fully extended position;

FIG. 8A is a top perspective view of an extendable lift assembly in a stowed position; and,

FIG. 8B is a top perspective view of the extendable lift assembly shown in FIG. 8A, in a deployed position.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The assembly of the present disclosure could be driven by hydraulics, electronics, pneumatics, and/or springs.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

By “non-rotatably connected” elements, we mean that: the elements are connected so that whenever one of the elements rotate, all the elements rotate; and relative rotation between the elements is not possible. Radial and/or axial movement of non-rotatably connected elements with respect to each other is possible, but not required.

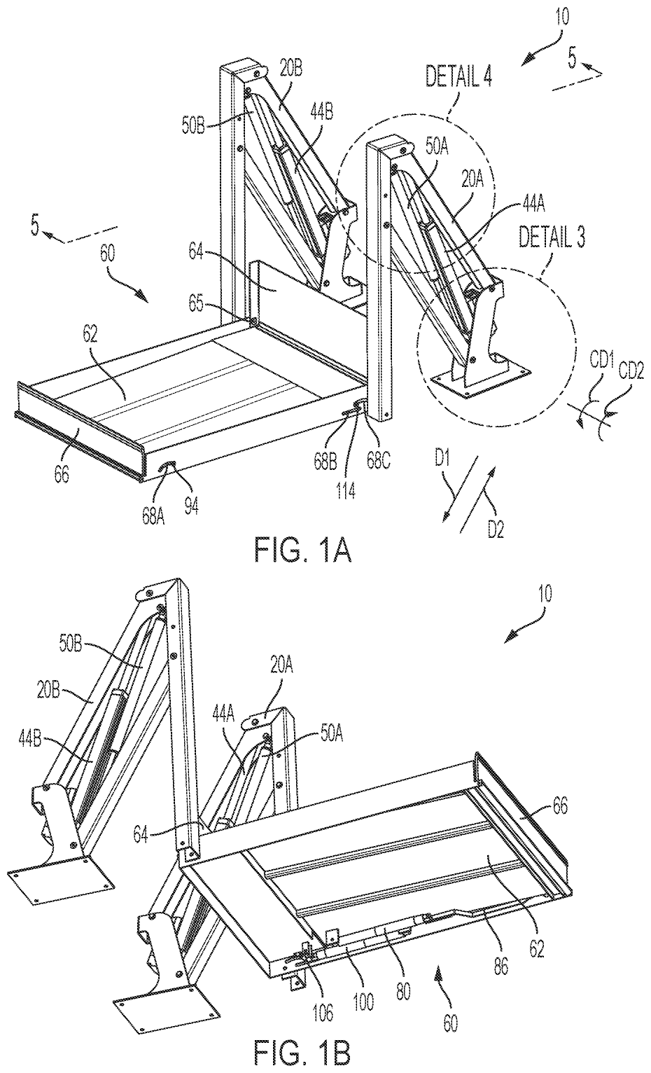

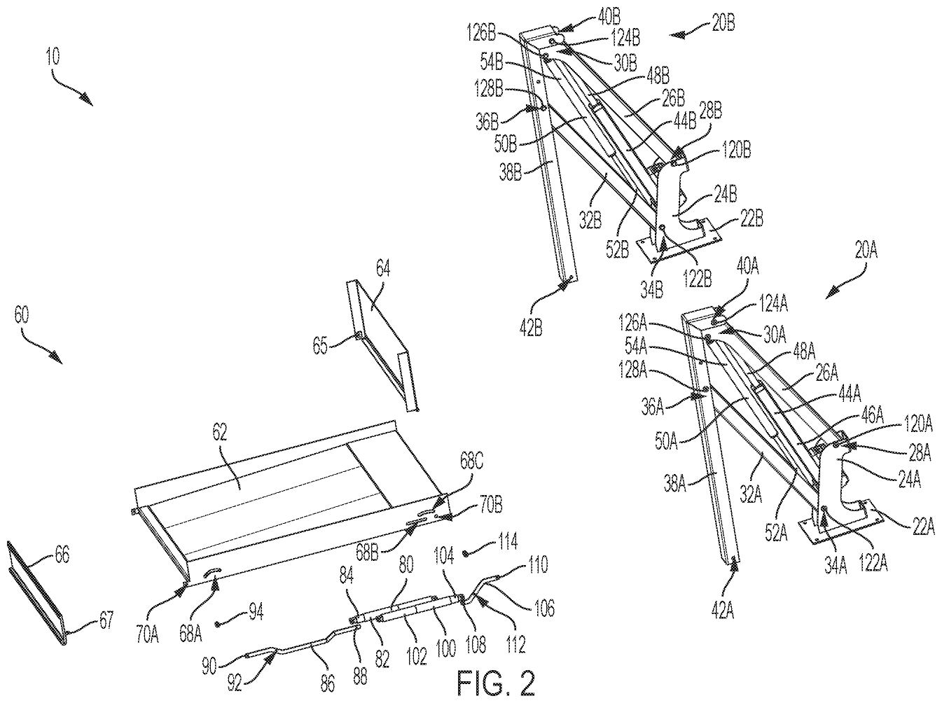

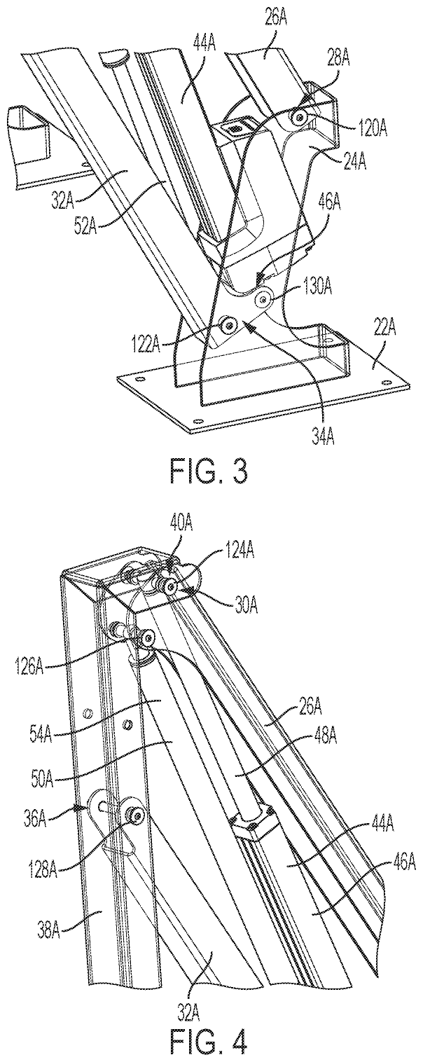

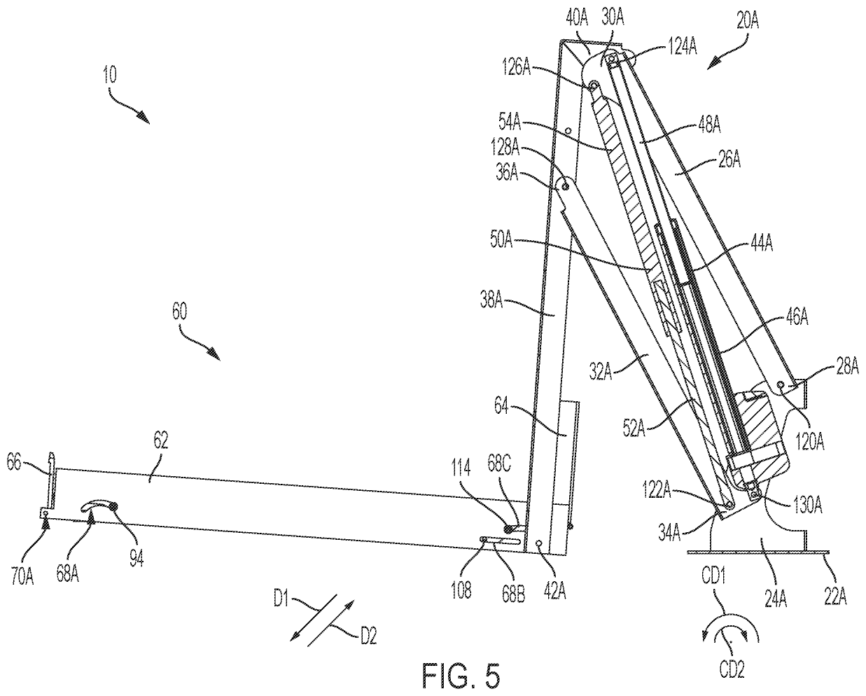

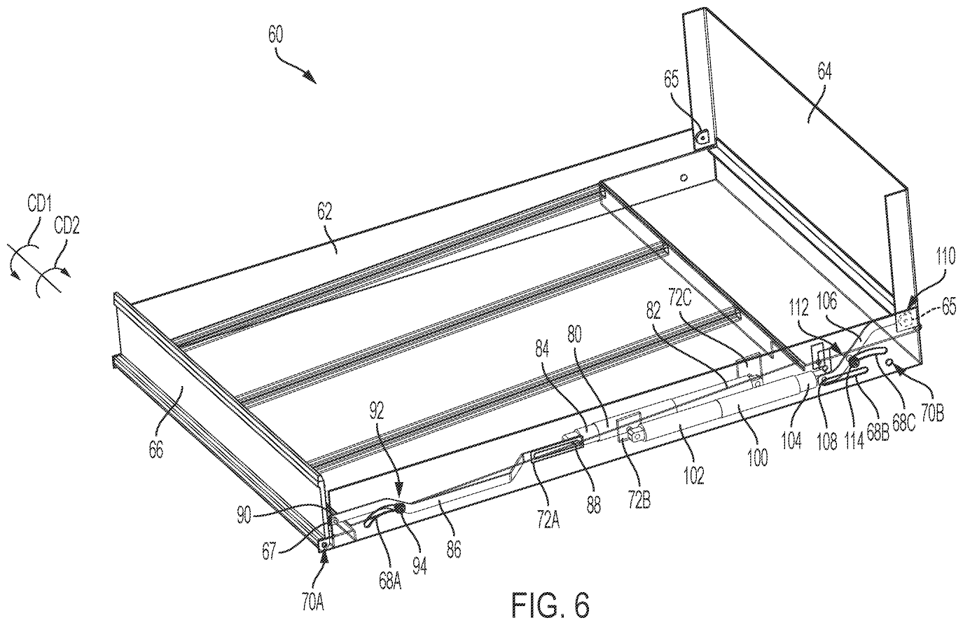

Referring now to the figures, FIG. 1A is a top perspective view of extendable lift assembly 10. FIG. 1B is a bottom perspective view of extendable lift assembly 10. FIG. 2 is an exploded top perspective view of extendable lift assembly 10. FIG. 3 is a detail view of extendable lift assembly 10 taken generally at Detail 3 in FIG. 1A. FIG. 4 is a detail view of extendable lift assembly 10 taken generally at Detail 4 in FIG. 1A. FIG. 5 is a cross-sectional view of extendable lift assembly 10 taken generally along line 5-5 in FIG. 1A. FIG. 6 is a top perspective view of platform assembly 60. Extendable lift assembly 10 generally comprises at least one leg assembly, for example, leg assembly 20A and leg assembly 20B, at least one actuator or drive, for example, actuator 44A and actuator 44B, at least one strut or gas strut or spring strut, for example, strut 50A and strut 50B, and platform assembly 60. The following description should be read in view of FIGS. 1-6.

Leg assembly 20A comprises bracket 24A, arm 26A, arm 32A, and arm 38A. Bracket 24A is operatively arranged to be fixedly secure to vehicle floor 4. In some embodiments, bracket 24A is secured to vehicle floor 4 via base plate 22A. Bracket 24A and/or base plate 22A may be secured to vehicle floor 4 via any suitable means, for example, bolts, rivets, screws, nails, welding, soldering, adhesives, etc. It should be appreciated that in some embodiments, bracket 24A and/or base plate 22A may be secured to a shiftable assembly that is secured to vehicle floor 4, such that extendable lift assembly 10 may be shifted to a position within the vehicle that is not proximate the doorway.

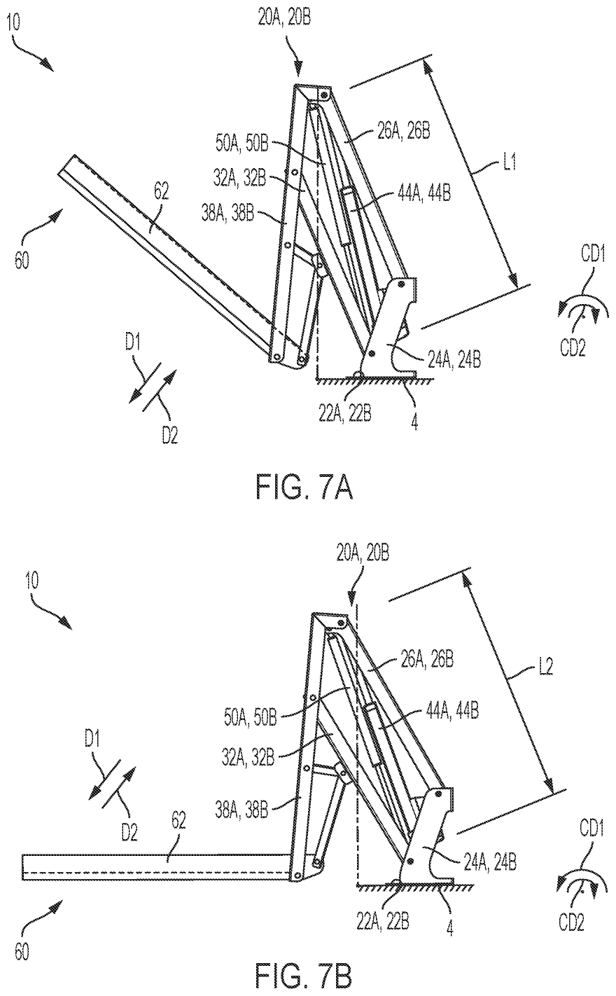

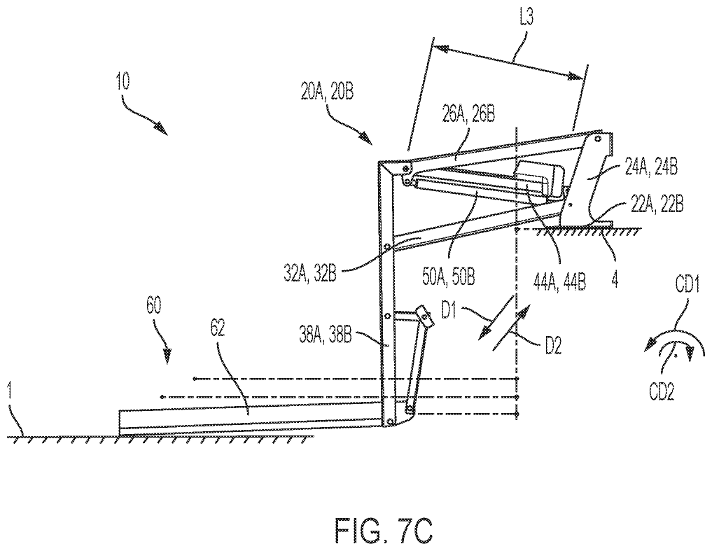

Arm 26A is generally a beam and comprises end 28A pivotably connected to bracket 24A and end 30A. End 28A is connected to bracket 24A via bolt or connector 120A. In some embodiments, and as best shown in FIGS. 4-5, end 30A comprises an ear or lobe or protrusion. Arm 38A is generally a beam and comprises end 40A pivotably connected to end 30A of arm 26A, and end 42A pivotably connected to platform assembly 60. In some embodiments, end 40A comprises an extension that is arranged generally perpendicular to arm 38A, the extension being pivotably connected to arm 26A. End 40A and/or the extension of end 40A is connected to end 30A via bolt or connector 124A. Arm 32A comprises end 34A pivotably connected to bracket 24A and end 36A pivotably connected to arm 38A. End 34A is connected to bracket via bolt or connector 122A. End 36A is connected to arm 38A via bolt or connector 128A. End 36A is connected to arm 38A at a point between and spaced apart from end 40A and 42A. In some embodiments, end 36A is connected to arm 38A proximate to a center point thereon. In some embodiments, end 36A is connected to arm 38A at a position between a center point thereon and end 40A. In some embodiments, arm 32A may be further connected to arm 38A via one or more arm members, as shown in FIGS. 7A-B.

Actuator or drive 44A is generally a linear actuator including housing or actuator housing 46A pivotably connected to bracket 34A and rod or piston rod 48A pivotably connected to arm 26A. As is known in the art of actuators, rod 48A is slidably and translatably and telescopingly connected to housing 46A. Specifically, rod 48A slides in and out of housing 46A in a linear direction. Housing 46A is connected to bracket 24A via bolt or connector 130A (see FIG. 3). Rod 48A is connected to arm 26A via bolt 124A. It should be appreciated that in some embodiments, housing 46A is pivotably connected to arm 26A and rod 48A is pivotably connected to bracket 24A. In some embodiments, actuator 44A comprises a THOMSON™ electric linear actuator. In some embodiments, actuator 44A comprises a STABILUS® actuator. It should be appreciated that any actuator suitable for extending and retracting may be used.

Strut or gas strut or spring strut 50A is a structural piece designed to resist pressure in the direction of its length. In some embodiments, strut 50A is a gas strut including rod 52A and housing or cylinder 54A. As is known in the art of struts, rod 52A is slidably and translatably and telescopingly connected to cylinder 54A, which is filled with a gas. As rod 52A is displaced into cylinder 54A, the gas therein is compressed thereby resisting retraction of strut 50A. Cylinder 54A is pivotably connected to end 30A of arm 26A. Specifically, cylinder 54A is connected to the ear of end 30A via bolt or connector 126A. Rod 52A is connected to end 34A of arm 32A. Specifically, rod 52A is connected to end 34A via bolt or connector 122A. It should be appreciated that in some embodiments, rod 52A is pivotably connected to arm 26A and cylinder 54A is pivotably connected to arm 32A. It should be appreciated that while strut 50A is envisioned as a gas strut to resist compression or retraction, any strut suitable for resisting compression or retraction may be used, for example a spring loaded strut.

Leg assembly 20A is operatively arranged to extend platform assembly 60 down to ground surface 1 and then retract platform assembly 60 back up to vehicle floor 4 and/or into the vehicle. To this end, and as will be described in greater detail below with respect to FIGS. 7A-C, actuator 44A retracts to extend platform assembly 60 and extends to retract platform assembly 60. Specifically, as actuator 44A retracts or shortens (i.e., rod 48A is displaced into housing 46A), leg assembly 20A displaces generally in circumferential direction CD1 and platform assembly 60 displaces generally in direction D1. As actuator 44A extends or lengthens (i.e., rod 48A is displaced out of housing 46A), leg assembly 20A displaces generally in circumferential direction CD2 and platform assembly 60 displaces generally in direction D2.

Leg assembly 20B is substantially the same as leg assembly 20A. Leg assembly 20B comprises bracket 24B, arm 26B, arm 32B, and arm 38B. Bracket 24B is operatively arranged to be fixedly secure to vehicle floor 4. In some embodiments, bracket 24B is secured to vehicle floor 4 via base plate 22B. Bracket 24B and/or base plate 22B may be secured to vehicle floor 4 via any suitable means, for example, bolts, rivets, screws, nails, welding, soldering, adhesives, etc. It should be appreciated that in some embodiments, bracket 24B and/or base plate 22B may be secured to a shiftable assembly that is secured to vehicle floor 4, such that extendable lift assembly 10 may be shifted to a position within the vehicle that is not proximate the doorway.

Arm 26B is generally a beam and comprises end 28B pivotably connected to bracket 24B and end 30B. End 28B is connected to bracket 24B via bolt or connector 120B. In some embodiments, end 30B comprises an ear or lobe or protrusion. Arm 38B is generally a beam and comprises end 40B pivotably connected to end 30B of arm 26B, and end 42B pivotably connected to platform assembly 60. In some embodiments, end 40B comprises an extension that is arranged generally perpendicular to arm 38B, the extension being pivotably connected to arm 26B. End 40B and/or the extension of end 40B is connected to end 30B via bolt or connector 124B. Arm 32B comprises end 34B pivotably connected to bracket 24B and end 36B pivotably connected to arm 38B. End 34B is connected to bracket via bolt or connector 122B. End 36B is connected to arm 38B via bolt or connector 128B. End 36B is connected to arm 38B at a point between and spaced apart from end 40B and 42B. In some embodiments, end 36B is connected to arm 38B proximate to a center point thereon. In some embodiments, end 36B is connected to arm 38B at a position between a center point thereon and end 40B. In some embodiments, arm 32B may be further connected to arm 38B via one or more arm members, as shown in FIGS. 7A-B.

Actuator or drive 44B is generally a linear actuator including housing or actuator housing 46B pivotably connected to bracket 34B and rod or piston rod 48B pivotably connected to arm 26B. As is known in the art of actuators, rod 48B is slidably and translatably and telescopingly connected to housing 46B. Specifically, rod 48B slides in and out of housing 46B in a linear direction. Housing 46B is connected to bracket 24B via bolt or connector 130B (not shown). Rod 48B is connected to arm 26B via bolt 124B. It should be appreciated that in some embodiments, housing 46B is pivotably connected to arm 26B and rod 48B is pivotably connected to bracket 24B. In some embodiments, actuator 44B comprises a THOMSON™ electric linear actuator. In some embodiments, actuator 44B comprises a STABILUS® actuator. It should be appreciated that any actuator suitable for extending and retracting may be used.

Strut or gas strut or spring strut 50B is a structural piece designed to resist pressure in the direction of its length. In some embodiments, strut 50B is a gas strut including rod 52B and housing or cylinder 54B. As is known in the art of struts, rod 52B is slidably and translatably and telescopingly connected to cylinder 54B, which is filled with a gas. As rod 52B is displaced into cylinder 54B, the gas therein is compressed thereby resisting retraction of strut 50B. Cylinder 54B is pivotably connected to end 30B of arm 26B. Specifically, cylinder 54B is connected to the ear of end 30B via bolt or connector 126B. Rod 52B is connected to end 34B of arm 32B. Specifically, rod 52B is connected to end 34B via bolt or connector 122B. It should be appreciated that in some embodiments, rod 52B is pivotably connected to arm 26B and cylinder 54B is pivotably connected to arm 32B. It should be appreciated that while strut 50B is envisioned as a gas strut to resist compression or retraction, any strut suitable for resisting compression or retraction may be used, for example a spring loaded strut.

Leg assembly 20B is operatively arranged to extend platform assembly 60 down to ground surface 1 and then retract platform assembly 60 back up to vehicle floor 4 and/or into the vehicle. To this end, and as will be described in greater detail below with respect to FIGS. 7A-C, actuator 44B retracts to extend platform assembly 60 and extends to retract platform assembly 60. Specifically, as actuator 44B retracts or shortens (i.e., rod 48B is displaced into housing 46B), leg assembly 20B displaces generally in circumferential direction CD1 and platform assembly 60 displaces generally in direction D1. As actuator 44B extends or lengthens (i.e., rod 48B is displaced out of housing 46B), leg assembly 20B displaces generally in circumferential direction CD2 and platform assembly 60 displaces generally in direction D2.

Platform assembly 60 comprises platform 62, bridge plate 64, and plate or roll stop 66. Platform 62 is arranged generally horizontal and is arranged such that a wheelchair or occupant arranged thereon can be lifted up to vehicle floor 4. In some embodiments, platform 62 comprises side walls to prevent the occupant from sliding off of platform 62 in a lateral direction. Platform 62 is pivotably connected to leg assemblies 20A-B, specifically, ends 42A-B of arms 38A-B, respectively. For example, ends 42A-B may be connected on either side of platform 62 to hole 70B via one or more bolts, rods, connectors, etc.

Bridge plate 64 is pivotably connected to platform 62. In some embodiments, bridge plate 64 is connected to platform 62 via a piano hinge. Bridge plate 64, when in a vertical position as shown in FIG. 1A, is operatively arranged to prevent the occupant from rolling or sliding off the front of platform 62. Once platform 62 has been lifted up to vehicle floor 4, bridge plate 64 is displaced in circumferential direction CD2 with respect to platform 62 until it engages vehicle floor 4 and is generally horizontal. Thus, in its horizontal position, bridge plate 64 “bridges” the gap between platform 62 and vehicle floor 4 thereby allowing the occupant to roll into or enter the vehicle from platform 62.

Plate 66 is pivotably connected to platform 62. In some embodiments, plate 66 is connected to platform 62 via hole 70A and one or more bolts, rods, connectors, etc. Plate 66, when in a vertical position as shown in FIG. 1A, is operatively arranged to prevent the occupant from rolling or sliding off the back of platform 62. Once platform 62 has been lowered to ground surface 1, platform 66 is displaced in circumferential direction CD1 with respect to platform 62 until it engages ground surface 1 and is generally horizontal. Thus, in its horizontal position, plate 66 provides a ramp from ground surface 1 to platform 62 that allows an occupant to roll onto platform 62 from ground surface 1. In some embodiments, plate 66 comprises a rubber member along its edge operatively arranged to engage ground surface 1.

In some embodiments, platform assembly 60 further comprises one or more actuators or drives, for example, actuator or drive 80 and actuator or drive 100. Actuator 80 comprises housing or cylinder 82 and rod 84. As is known in the art of actuators, rod 84 is linearly displaceable into and out of cylinder 82. Cylinder 82 is connected to platform 62, for example, via plate 72C, as shown in FIG. 6. Rod 84 is slidably connected to platform 62, for example, via plate 72A. Arm 86 connects rod 84 to plate 66. Arm 86 comprises end 88 connected to rod 84 and end 90 connected to plate 66. In some embodiments, end 90 is connected to plate 66 via hole or tab 67, which is arranged proximate to a center point of plate 66. As rod 84 extends out of cylinder 82, arm 86 displaces plate 66 in circumferential direction CD1 with respect to platform 62. In some embodiments, and as shown, arm 86 may be further slidably connected to platform 62 at point 92 via bolt or connector 94. For example, connector 94 may extend through arm 86 at point 92 and engage hole 68A. In some embodiments, hole 68A is an arched or a curvilinear slot. In some embodiments, arm 86 is non-linear.

Actuator 100 comprises housing or cylinder 102 and rod 104. As is known in the art of actuators, rod 104 is linearly displaceable into and out of cylinder 102. Cylinder 102 is connected to platform 62, for example, via plate 72B, as shown in FIG. 6. Rod 104 is slidably connected to platform 62, for example, via hole 68B and a bolt or connector. Arm 106 connects rod 104 to plate 64. Arm 106 comprises end 108 connected to rod 104 and end 110 connected to plate 64. In some embodiments, end 110 is connected to plate 64 via hole or tab 65. As rod 104 extends out of cylinder 102, arm 106 displaces plate 64 in circumferential direction CD2 with respect to platform 62. In some embodiments, and as shown, arm 106 may be further slidably connected to platform 62 at point 112 via bolt or connector 108. For example, connector 108 may extend through arm 106 at point 112 and engage hole 68C. In some embodiments, hole 68C is an arched or a curvilinear slot. In some embodiments, arm 106 is non-linear.

FIG. 7A is a side elevational view of extendable lift assembly 10 in a partially stowed position. As shown, actuator 44A, 44B have length L1. Length L1 may be near or at the max length of actuator 44A, 44B. From the position shown in FIG. 7A, when actuator 44A, 44B extends/lengthens, arm 26A, 26B displaces in circumferential direction CD2. When actuator 44A, 44B retracts/shortens, arm 26A, 26B displaces in circumferential direction CD1.

FIG. 7B is a side elevational view of extendable lift assembly 10 in a partially extended position. As shown, actuator 44A, 44B has contracted/shortened such that it has length L2. Length L2 is less than length L1. The result of such contraction is displacement of arm 26A, 26B and leg assembly 20A, 20B in circumferential direction CD1, thus extending platform assembly 60 toward ground surface 1.

FIG. 7C is a side elevational view of extendable lift assembly 10 in a fully extended position. As shown, actuator 44A, 44B has contracted/shortened such that it has length L3. Length L3 is less than length L2. The result of such contraction is displacement of arm 26A, 26B and leg assembly 20A, 20B in circumferential direction CD1, thus extending platform assembly 60 to ground surface 1. FIG. 7C shows actuator 44A, 44B at or near its minimum length. Platform 62 is engaged with ground surface 1. In the fully extended position, strut 50A, 50B is exerting maximum force on leg assembly 20A, 20B, specifically, arm 26A, 26B, in circumferential direction CD2 (i.e., toward the stowed position). Such force exerted by strut 50A, 50B reduces the amount of power used by actuator 44A, 44B to lift the occupant up to vehicle floor 4.

In some embodiments, the various actuators within extendable lift assembly 10 are controlled by a circuit (e.g., a high amperage circuit board). The circuit, for example, can be arranged as a main controller for extendable lift assembly 10. In some embodiments, one or more sensors (e.g., proximity sensors) are arranged on or near extendable lift assembly 10. Such sensors detect, for example, when platform assembly 60 is at or near ground surface 1 and/or when platform assembly 60 is at or near vehicle floor 4 or inside of the vehicle. These sensors communicate with the circuit to provide position data regarding platform assembly 60 (i.e., is platform assembly in the fully extended position, the partially extended position, the partially stowed position, or the fully stowed position). In some embodiments, extendable lift assembly comprises one or more sensors operatively arranged to detect the presence of an occupant arranged on platform 62. Such sensors may communicate with a main controller or the circuit to communicate to activate and deactivate the actuators. In some embodiments, one or more additional sensors may be employed to detect the position of plate 64 and/or plate 66 and communicate with actuators 80 and 100. In some embodiments, communication between actuators 44A, 44B, 80, and 100 and their control circuit, and the main controller occurs via Controller Area Network (CAN bus).

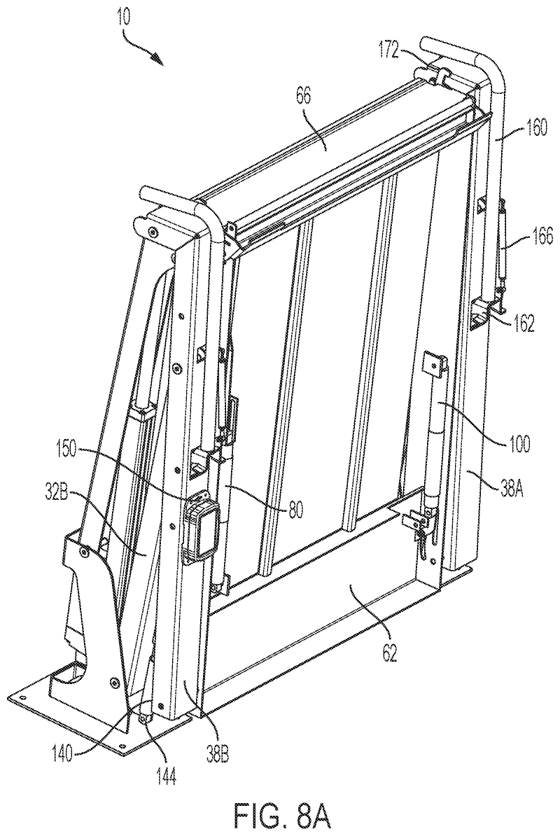

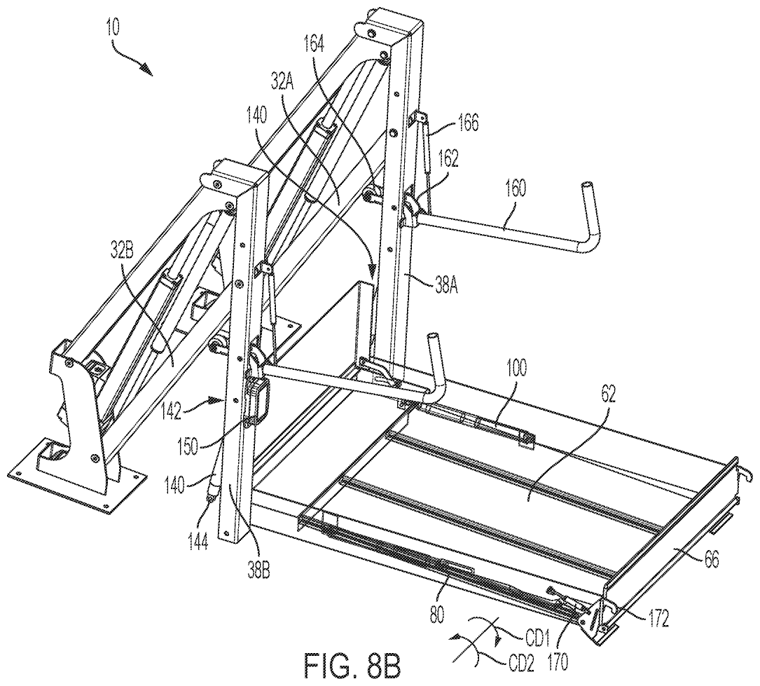

FIG. 8A is a top perspective view of extendable lift assembly 10 in a stowed position. FIG. 8B is a top perspective view of extendable lift assembly 10 shown in FIG. 8A, in a deployed position. As shown in FIGS. 8A-B, extendable lift assembly 10 may comprise additional features. The following description should be read in view of FIGS. 1A-8B.

In some embodiments, extendable lift assembly 10 further comprises one or more actuators or drives 140. Actuator 140 comprises end 142 pivotably connected to arm 38A, 38B and end 144 pivotably connected to platform 62. Actuator 140 is operatively arranged to displace platform 62 in circumferential direction CD1 and circumferential direction CD2 with respect to arms 38A-B.

In some embodiments, extendable lift assembly 10 further comprises control box or panel 150. Control box 150 is operatively arranged to control the various actuators and drives of extendable lift assembly 10. For example, control box 150 may have one or more buttons or switches to move platform 62 up and down, move extendable lift assembly 10 between the stowed and deployed positions, etc. In some embodiments, control box 150 comprises a screen or a touch screen. In some embodiments, control box 150 comprises a variable speed paddle wherein control box 150 commands extendable lift assembly 10 based on the magnitude in which the paddle is moved. Thus, displacing the paddle a greater magnitude will result in the actuators of extendable lift assembly 10 displacing faster, and displacing the paddle a lesser magnitude will result in the actuators of extendable lift assembly 10 displacing slower. This feature allows a user to control the displacement speed of extendable lift assembly 10 on a passenger by passenger basis (i.e., an elderly passenger should be moved slower than a box of widgets).

In some embodiments, extendable lift assembly 10 further comprises one or more handles 160. Handle 160 is capable of moving from a stowed position shown in FIG. 8A to a deployed position shown in FIG. 8B. Handle 160 is non-connected to bracket 162. Bracket 162 is rotatably connected to arm 38A, 38B. Wheel or roller 164 is rotatably connected to bracket 162 and operatively arranged to engage arm 32A, 32B. As extendable lift assembly 10 moves from the stowed position shown in FIG. 8A to the deployed position shown in FIG. 8B, arm 32A, 32B displaces away from arm 38A, 38B, allowing wheel 164 to roll along arm 32A, 32B in circumferential direction CD1. As such, arm 160 displaces in circumferential direction CD1 with respect to arm 38A, 38B. As extendable lift assembly 10 moves from the deployed position shown in FIG. 8B to the stowed position shown in FIG. 8A, arm 32A, 32B moves toward arm 38A, 38B forcing wheel 164 in circumferential direction CD1. As a result, arm 160 displaces in circumferential direction CD2 with respect to arm 38A, 38B. In some embodiments, extendable lift assembly 10 further comprises one or more pistons or struts 166 operatively arranged to bias arm 160 in circumferential direction CD1. This bias prevents arms 160 from flopping around during use, and also aids in the deployment of arms 160.

In some embodiments, extendable lift assembly 10 further comprises one or more hooks 172. Hook 172 is rotatably connected to platform 62 and operatively arranged to engage plate or roll stop 66. When engaged, hook 172 prevents plate 66 from rotating in circumferential direction CD1 with respect to platform 62. When disengaged, plate 66 is capable of displacing in circumferential direction CD1 with respect to platform 62. In some embodiments, extendable lift assembly 10 further comprises one or more pistons or struts 170. Piston 170 is operatively arranged to bias hook 172 in circumferential direction CD1 with respect to platform 62, and into engagement with plate 66.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

1 Ground surface

4 Vehicle floor

10 Extendable lift assembly

20A Leg assembly

20B Leg assembly

22A Base plate

22B Base plate

24A Bracket

24B Bracket

26A Arm

26B Arm

28A End

28B End

30A End

30B End

32A Arm

32B Arm

34A End

34B End

36A End

36B End

38A Arm

38B Arm

40A End

40B End

42A End

42B End

44A Actuator or drive

44B Actuator or drive

46A Housing or actuator housing

46B Housing or actuator housing

48A Rod or piston rod

48B Rod or piston rod

50A Strut or gas strut or spring strut

50B Strut or gas strut or spring strut

52A Rod

52B Rod

54A Housing or cylinder

54B Housing or cylinder

60 Platform assembly

62 Platform

64 Bridge plate

65 Hole or tab

66 Plate or roll stop

67 Hole or tab

68A Hole

68B Hole

68C Hole

70A Hole

70B Hole

72A Plate

72B Plate

72C Plate

80 Actuator or drive

82 Housing or cylinder

84 Rod

86 Arm

88 End

90 End

92 Hole or point

94 Bolt or connector

100 Actuator or drive

102 Housing or cylinder

104 Rod

106 Arm

108 End

110 End

112 Hole or point

114 Bolt or connector

120A Bolt or connector

120B Bolt or connector

122A Bolt or connector

122B Bolt or connector

124A Bolt or connector

124B Bolt or connector

126A Bolt or connector

126B Bolt or connector

128A Bolt or connector

128B Bolt or connector

130A Bolt or connector

130B Bolt or connector (not shown)

140 Actuator or drive

142 End

144 End

150 Control box or panel

160 Handle

162 Bracket

164 Wheel

166 Piston or strut

170 Piston or strut

172 Hook

CD1 Circumferential direction

CD2 Circumferential direction

D1 Direction

D2 Direction

What is claimed is:

1. An extendable lift assembly, comprising:
at least one leg assembly, each leg assembly of the at least one leg assembly including:
a bracket;
a first arm pivotably connected to the bracket;
a second arm pivotably connected to the first arm;
a first actuator extending between the bracket and the first arm; and,
a strut extending between the bracket and the first arm; and,
a platform assembly pivotably connected to the second arm.

2. The extendable lift assembly as recited in claim 1, wherein the first actuator is operatively arranged to displace the first arm circumferentially with respect to the bracket.

3. The extendable lift assembly as recited in claim 2, wherein the first actuator is pivotably connected to the bracket at a first end and pivotably connected to the first arm at a second end.

4. The extendable lift assembly as recited in claim 1, wherein the strut biases the first arm in a first circumferential direction with respect to the bracket.

5. The extendable lift assembly as recited in claim 4, wherein the strut comprises a gas strut including a cylinder and a rod, wherein the strut is pivotably connected to the bracket at a first end and pivotably connected to the first arm at a second end.

6. The extendable lift assembly as recited in claim 1, further comprising a third arm pivotably connected to the bracket at a first end and pivotably connected to the second arm at a second end.

7. The extendable lift assembly as recited in claim 1, wherein the platform assembly comprises:
a platform pivotably connected to the second arm; and,
at least one plate pivotably connected to the platform.

8. The extendable lift assembly as recited in claim 7, wherein the at least one plate comprises:
a first plate connected to a first end of the platform; and,
a second plate connected to a second end of the platform.

9. The extendable lift assembly as recited in claim 8, wherein the platform assembly further comprises:
a second actuator operatively arranged to circumferentially displace the first plate relative to the platform; and,
a third actuator operatively arranged to circumferentially displace the second plate relative to the platform.

10. The extendable lift assembly as recited in claim 1, wherein:
retraction of the first actuator displaces the at least one leg assembly and platform assembly in a first circumferential direction; and,
extension of the first actuator displaces the at least one leg assembly and platform assembly in a second circumferential direction, opposite the first circumferential direction.

11. An extendable lift assembly for a vehicle, comprising:
at least one leg assembly, each leg assembly of the at least one leg assembly including:
a bracket operatively arranged to be mounted to a floor of the vehicle;
a first arm pivotably connected to the bracket;
a second arm pivotably connected to the first arm;
a first actuator extending from the bracket to the first arm, wherein the first actuator is operatively arranged to displace the first arm circumferentially with respect to the bracket; and,
a strut extending from the bracket to the first arm; and, a platform assembly pivotably connected to the second arm.

12. The extendable lift assembly as recited in claim 11, wherein the first actuator is pivotably connected to the bracket at a first end and pivotably connected to the first arm at a second end.

13. The extendable lift assembly as recited in claim 11, wherein the strut biases the first arm in a first circumferential direction with respect to the bracket.

14. The extendable lift assembly as recited in claim 13, wherein the strut comprises a gas strut including a cylinder and a rod, wherein the strut is pivotably connected to the bracket at a first end and pivotably connected to the first arm at a second end.

15. The extendable lift assembly as recited in claim 11, further comprising a third arm pivotably connected to the bracket at a first end and pivotably connected to the second arm at a second end.

16. The extendable lift assembly as recited in claim 15, wherein the third arm is connected to the second arm at a position spaced apart from each end of the second arm.

17. The extendable lift assembly as recited in claim 11, wherein the platform assembly comprises:
a platform pivotably connected to the second arm; and,
at least one plate pivotably connected to the platform.

18. The extendable lift assembly as recited in claim 17, wherein the at least one plate comprises:
a first plate connected to a first end of the platform; and,
a second plate connected to a second end of the platform.

19. The extendable lift assembly as recited in claim 18, wherein the platform assembly further comprises:
a second actuator operatively arranged to circumferentially displace the first plate relative to the platform; and,
a third actuator operatively arranged to circumferentially displace the second plate relative to the platform.

20. The extendable lift assembly as recited in claim 11, wherein:
retraction of the first actuator displaces the at least one leg assembly and platform assembly in a first circumferential direction; and,
extension of the first actuator displaces the at least one leg assembly and platform assembly in a second circumferential direction, opposite the first circumferential direction.
